(19) United States
(12) Patent Application Publication
(10) Pub. No.: US 2009/0140570 A1
(43) Pub. Date: Jun. 4, 2009

(54) REMOVABLE WHEEL SYSTEM

(76) Inventor: Jeff Houkal, Tempe, AZ (US)

Correspondence Address: MILLER NASH LLP, 601 UNION STREET, SUITE4400, SEATTLE, WA, 98101-2352, US

(21) Appl. No.: 12/363,622

(22) Filed: Jan. 30, 2009

Related U.S. Application Data
(63) Continuation-in-part of application No. 11/312,798, filed on Dec. 20, 2005.
(60) Provisional application No. 60/637,683, filed on Dec. 20, 2004.

(51) Int. Cl. B60B 37/00

(52) U.S. Cl. 301/1

(57) ABSTRACT

The present invention is directed to devices having wheels, and more specifically, a method and device for making the wheels readily detachable and interchangeable by users. The removable wheel system comprises a removable axle, a wheel, an optional shield, and a hangar to be assembled in connection with a skateboard. The present invention provides a wheel and hangar using a removable axle for a removable wheel system that is easily removable, replaceable, durable, and protectable against dust accumulation while providing the strength necessary to withstand the rigors and stresses imposed on the system during use.

### CROSS-REFERENCE TO RELATED APPLICATIONS

This present application is a continuation-in-part of U.S. patent application Ser. No. 11/312,798, filed Dec. 20, 2005; which claims the benefit of priority of U.S. Provisional Application No. 60/637,683, filed Dec. 20, 2004. The present application is based on and claims priority from these applications, the disclosures of which are hereby expressly incorporated herein by reference.

### BACKGROUND

The present invention is directed to devices having wheels, and more specifically, a method and device for making the wheels easily detachable and interchangeable using a removable axle between the wheel and the hangar.

It is easy for the wheels of skateboards, roller skates and the like to be subjected to much stress, fracture, erosion, shock and other rigors due to continued use. The wheels of skateboards are commonly made from polyurethane, plastics and other similar materials to provide smooth and continued rolling. These materials, however, are easily worn out due to friction and shock from hitting against hard, ground surfaces. Smooth rolling of the wheels as well as easy replacement of damaged wheels are absolutely integral in preventing injury to users and for users to safely enjoy skateboarding activities. Typically, replacement of the wheels requires tools to remove the tightly connected retaining nut and much time and effort to clean out debris having entered the wheel assembly, such as grit, sand, dirt, and dust.

Consequently, it would be desirable to provide a wheel and hangar using a removable axle for a removable wheel system that is easily removable, replaceable, durable, and protectable against dust accumulation while providing the strength necessary to withstand the rigors and stresses imposed on the system during use.

### SUMMARY OF THE INVENTION

The present invention provides new technology by which the wheels are easily interchanged and detached as the removable wheel system by use of the removable axles, strengthened by way of design to withstand the shock and rigors of skateboarding activities, and protects the removable wheel system against dust and debris from entering the assembled removable wheel system.

The removable wheel system comprises a removable axle having a head portion, a body portion, and an end portion, a wheel having a central opening through which the removable axle slidably passes, and a hangar having a base portion and an axle-receiving member on each lateral side of the base with the axle-receiving member having a cylindrical cavity into which each of the removable axles fits and extends into the cylindrical cavity of the base portion, whereby the axle is removably connected to the hangar and attaches the wheel to the hangar.

Another embodiment of the removable wheel system of a skateboard comprises a removable axle having a head portion, a body portion, and an end portion with the end portion having a threaded surface, the optional protector of a substantially circular shape coupled between the head portion and the body portion to prevent debris from entering the system, a wheel with a central opening through which the removable axle slidably passes, and a hangar having a base portion and an axle-receiving member on each lateral side of the base portion, the axle-receiving member having a cylindrical cavity into which each of the removable axles fits and extends into the cylindrical cavity of the base portion, and whereby the axle is removably connected to the hangar and attaches the wheel to the hangar.

The axle-receiving members are constructed of materials with higher strength properties than the materials from which the hangar is made to withstand stress imposed on the removable wheel system, more particularly the axle-receiving members and removable axles.

The removable axles are removably and threadably engaged through the cylindrical cavity of the axle-receiving members and connected to the internally threaded portion of the cylindrical cavity of the base portion of the hangar for an easily interchangeable, replaceable, and adaptable mechanism to repair or replace the wheels.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

The accompanying drawings, which are incorporated in and constitute a part of this specification, illustrate various exemplary embodiments.

FIG. 1 is an exploded view of the removable wheel system set forth herein showing the removable axle from the wheel and hangar on the left side and assembled on the right side.

FIG. 2 is a detailed perspective view of the removable axle of the removable wheel system of FIG. 1.

FIG. 3 is an exploded cross sectional view of the removable wheel system of FIG. 1 before assembly on the left side and when assembled on the right side.

FIG. 4 is a partial perspective, bottom view of the board attached to the removable wheel system of FIG. 1 to form a skateboard.

Similar reference characters denote corresponding features consistently throughout the attached drawings.

### DETAILED DESCRIPTION OF THE FIGURES

The detailed description set forth below in connection with the appended drawings is intended as a description of presently-preferred embodiments of the invention and is not intended to represent the only forms in which the present invention may be constructed and/or utilized. The description sets forth the functions of and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present invention is directed to devices having wheels, and more specifically, a method and system for making the wheels of a device easily and readily detachable and interchangeable. The removable wheel system 10 may be used in connection with any device that incorporates wheels. Without limiting the scope of the invention, exemplary devices with which the removable wheel system 10 may be used include, but are not limited to a skateboard, skates, wheelchairs, automobiles, trailers and tractors. However, for purposes of this detailed description, the removable wheel system 10 will be described and shown as used in connection with a skateboard 30. The present invention is further made from fewer components and the removable wheel system 10 is simpler to connect, take apart, interchange, prevent dust from entering the system 10 and provide greater strength to withstand the shock typically imposed on the skateboard assembly 50 by the users.

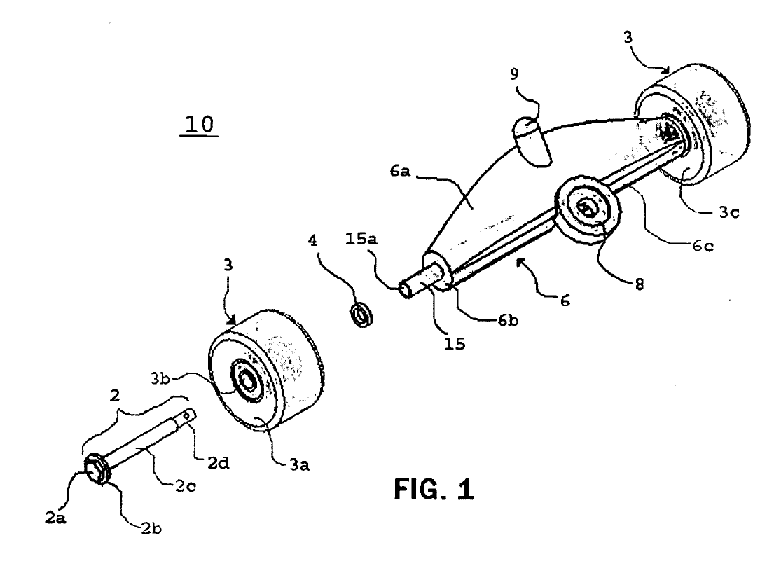

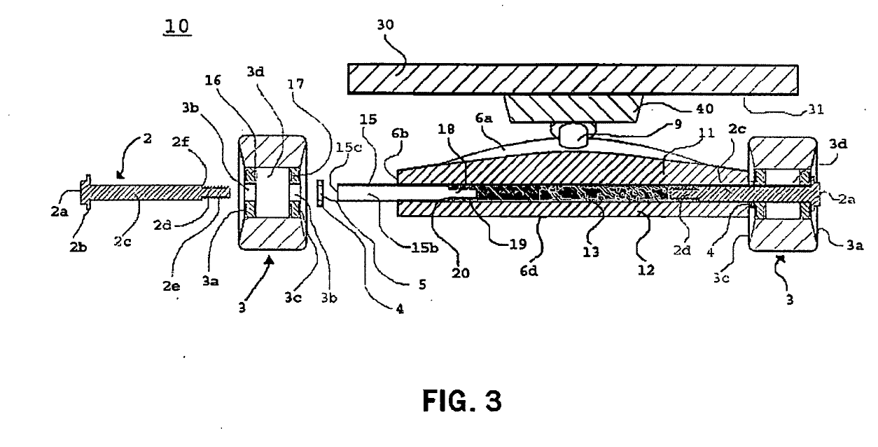

FIG. 1 is an exploded view of the removable wheel system 10 as set forth herein showing the removable axle 2 from the wheel 3 and hangar 6 on the left side and fully assembled on the right side. FIG. 1 of the removable wheel system 10 can be easily visualized with FIG. 3, the cross-sectional view of the system 10 which will be discussed in later sections. Referring to FIG. 1, the removable wheel system 10 includes a removable axle 2, a wheel 3, an optional shield 4, and a hangar 6. The removable wheel system 10 as shown in FIG. 1 is symmetrical about a center line and the opposed side is preferably identical to the side shown in FIG. 1. Therefore, when the removable wheel system 10 is discussed in relation to only one side, it can be appreciated that the left side is identical to right side but that they are on the opposite sides of the hangar 6.

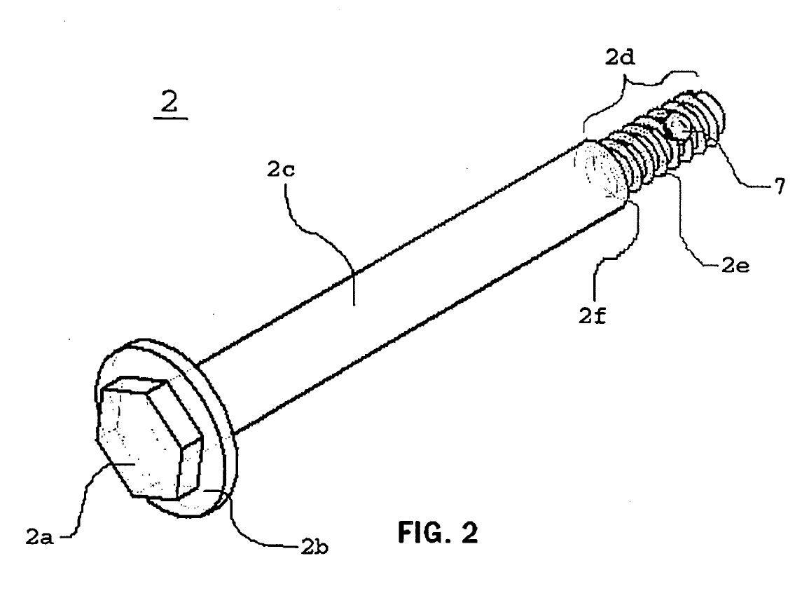

FIG. 2 is a detailed perspective view of the removable axle 2 of the removable wheel system 10 of FIG. 1. As illustrated more clearly in FIG. 2, the removable axle 2 comprises a head portion 2a, an optional protector 2b, a body portion 2c, and an end portion 2d. The removable axle 2 is a separate structure that connects and retains the wheel together with the hangar 6. The head portion 2a comprises a screw cap, a hex head, a multi-sided head, a socket that accepts a key or any type of a simple head drive such as a phillips head drive, or the like so that a user can easily grasp the head portion 2a or use a simple key/drive to tighten the wheel 3 against the hangar 6. The methods of assembling the removable wheel system 10 are further discussed in a later section in connection with FIG. 3. The optional protector 2b comprises a circular, disc-like shape with a larger surface area than the head portion 2a. The optional protector 2b is primarily disposed between the head portion 2a and the outer lateral side of the wheel 3a, more specifically to cover the central opening of the wheel 3b, to prevent and protect the removable wheel system 10 from debris such as dust, sand, dirt, and grit. The optional protector 2b may be a separate part. Alternatively, the optional protector 2b may be a pre-manufactured part of the removable axle 2 as shown in FIGS. 1-2 as the removable axle 2 is pre-manufactured as a single structure.

The body portion 2c of the removable axle 2 is cylindrical and elongated. The surface of the body portion 2c is smooth. The end portion 2d of the removable axle 2 is also cylindrical and has a threaded surface 2e. The threaded surface 2e of the end portion 2d threads into the smaller cylindrical cavity 18 (illustrated in FIG. 3) of the hangar 6 by engaging against the complementary and internally threaded portion 19 of the smaller cylindrical cavity 18 (illustrated in FIG. 3). Even though the exemplary embodiment illustrates a threaded surface 2e, the present invention is not limited to using a threaded surface 2e of the removable axle 2 to removably engage the hangar 6. Any means of connecting, retaining, engaging or coupling the removable axle 2 to the hangar 6 may be used to hold the wheel 3 and the removable wheel system 10 in place. Exemplary surfaces of the end portion 2d of the removable axle 2 may include, but are not limited to a threaded, starred, hexed, keyed, rectangular, toothed, or a similar surface.

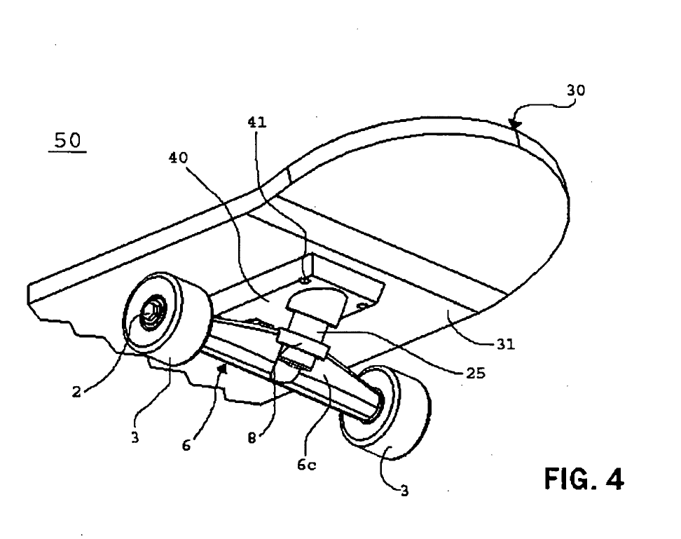

The end portion 2d of the removable axle 2 also comprises a locking member 7. The locking member 7 can be any means of locking the removable axle 2 to the internal, cylindrical cavity 18 of the base portion 6a of the hangar 6 as shown in FIG. 3. The locking member 7 can be comprised of a nylon nubbin, a small protrusion, or the like to create friction against the internal, cylindrical cavity 18 of the base portion 6a to prevent disengaging of the removable axle 2 due to continued use and the rigors of skateboarding by users. The vibration caused by continued use of the skateboard 50 (illustrated in FIG. 4) may cause the removable axle 2 to disengage from the hangar 6. Consequently, the locking member 7 is a safety measure and acts to create enough friction and resistance to prevent the removable axle 2, or the end portion 2d of the removable axle 2, from disengaging and becoming loose from the hangar 6. The removable axle 2 may be pre-manufactured as a single structure including the optional protector 2b and has a shape of a bolt. The removable axle 2 may also be pre-manufactured as a single structure with the head portion 2a, body portion 2c, and end portion 2 with the locking member 7.

The wheel 3 is preferably removably connected to the hangar 6 by the removable axle 2. The wheel 3 may include any type of wheel that is commonly used in the industry. The wheel 3 may be manufactured from any material commonly used in the industry such as polyurethane, plastics and the like. The wheel 3 may optionally include captive bearings, and may be any bearing commonly used in the industry. The wheel bearings may be manufactured from any material including, but not limited to metal or plastic, and may consist of an outer and inner race along with ball or cylinder bearings arranged annularly between the races. The removable wheel system 10 is easily adaptable and usable with any standard wheel used in skateboarding. Customized wheels are not required to practice the present invention. The removable axle 2 retrofits any standard skateboard wheel 3.

The hangar 6 comprises a base portion 6a with lateral surfaces 6b, a frontal surface 6c, a bushing receiver 8, a connector 9, and an axle-receiving member 15 on each of the lateral surfaces 6b of the hangar 6. The hangar 6 is relatively triangular in shape with the lateral sides nearly expanding the width of the board 30 (illustrated in FIG. 4). On each lateral side or lateral surface 6b of the base portion 6a, the axle-receiving members 15 extend outwardly at an x-axis. The bushing 25 (illustrated in FIG. 4) and the connector 9 upwardly attach the removable wheel system 10 to the base plate 40 (illustrated in FIG. 4) thereby upwardly attaching to and supporting the board 30 (illustrated in FIG. 4) in order to support the weight of a user. The bushing receiver 8 with its opening holds the bushing 25 in place.

The axle-receiving members 15 are substantially cylindrically shaped with a larger cylindrical cavity 15b that protrude outwardly from the lateral surfaces 6b of the hangar 6 at an x-axis. The axle-receiving members 15 are permanently affixed to the lateral surfaces 6b of the hangar. The outer diameter 15a of the axle-receiving members 15 matches the diameter of the body portion 2c of the removable axle 2 so that the removable axles 2 can easily pass through the axle-receiving members 15 and into the hangar 6. The outer diameter 15a of the axle-receiving member 15 is approximately similar in size as the diameter of the wheel 3 so that the wheel 3 may be assembled with the axle-receiving member 15 through which the wheel 3 fits over the axle-receiving member 15. Generally, the outer diameter of the axle-receiving member 15 is approximately 0.2 to 0.5 inches to accommodate the standard wheels of skateboards. The inner diameter 15c of the axle-receiving member 15 depends on the type of material used that can be thicker or thinner and naturally affecting the inner diameter 15c of the axle-receiving member 15. The outer diameter 15a of the axle-receiving member 15 is approximately similar to the diameter of the central opening 3b of any wheel for which the present invention is applied. The length of the axle-receiving members 15 is approximately the internal length of the central opening 3b of the wheel 3 or approximately the length of the body portion 2c of the removable axle 2. The axle-receiving members 15 act as a housing and channel for the body portion 2c of the removable axles 2 through which the removable axles 2 fit.

The base portion 6a of the hangar 6 may be constructed of materials including, but not limited to metals, composites, or a combination thereof, that can be either solid or sectionally assembled. The axle-receiving members 15 may be constructed of materials including, but not limited to metals, composites, or a combination thereof, that have stronger and more durable properties than the materials used to make the hangar 6. Because the removable wheel system 2, more particularly each of the axle-receiving members 15, receives and absorbs most of the shock and stress imposed on the skateboard 50 (illustrated in FIG. 4) during use, it is required that the axle-receiving members 15 are constructed of materials with higher strength properties to prevent the axle-receiving members 15 from breaking off of the base portion 6a of the hangar 6 during use.

For example, the base portion 6a of the hangar 6 may be constructed of aluminum, titanium, or carbon fiber, and the axle-receiving members 15 may be constructed of steel. These examples are meant to be exemplary and not limited to these specific materials or combinations thereof. The base portion 6a of the hangar 6 may be constructed from any metal, composite or a combination thereof as long as the axle-receiving members 15 are constructed of materials with higher strength properties that are capable of withstanding higher stress than the materials from which the base portion 6a is made. Further, the axle-receiving members 15 also provide additional strength and rigidity for the removable axles 2 to retain the wheels 3 while providing users with an interchangeable, detachable, and replaceable wheel mechanism to readily replace or repair the wheels 3.

As shown in FIG. 1, the removable wheel system 10 may include an optional shield 4 to be disposed between the inner lateral side 3c of the wheel 3 and the hangar 6. The optional shield 4 is of a substantially circular and flat-disc shape or a washer to be disposed between the wheel 3 and the hangar 6 in providing a slight distance between the wheel 3 and the base portion 6a of the hangar 6 when the removable wheel system 10 is fully assembled. The optional shield 4 prevents damage to the inner lateral side 3c of the wheel 3 due to continued use and constant rolling of the wheels 3 against the lateral surface 6b of the hangar 6. The optional shield 4 fits around the axle-receiving member 15 and is disposed between the wheel 3 and the lateral surface 6b of the base portion 6a. The optional shield 4 may be a separate structure that is inserted during assembly of the removable wheel system 10. Alternatively, the optional shield 4 may be manufactured as a permanently affixed component of the hangar 6 with the shield on the lateral surfaces 6b of the hangar 6.

FIG. 3 is an exploded cross sectional view of the removable wheel system 10 of FIG. 1 before assembly on the left side and when assembled on the right side. The methods of assembling the removable wheel system 10 is quite simple. The optional shield 4 is assembled by slidably passing the axle-receiving member 15 through the aperture of the shield 4 so that the optional shield 4 touches the lateral surface 6b of the hangar 6. The wheel 3 is then inserted over the axle-receiving member 15, or the axle-receiving member 15 slidably and removably passes through the central opening 3b of the wheel 3. The axle-receiving member 15 is removably engaging the optional shield 4 and the wheel 3 as the shield 4 and the wheel 3 slidably sit around the axle-receiving member 15. The removable axle 2 is then removably inserted through the larger cylindrical cavity 15b. A user can then take the head portion 2a of the removable axle 2 and twist in a clockwise direction in order to removably thread and engage the removable axle 2 into the smaller cylindrical cavity 18 of the hangar 6.

The base portion 6a of the hangar 6 comprises an upper cross section 11, a middle cross section 13 and a lower cross section 12. Alternatively, the base portion 6a of the hangar 6 comprises an upper cross section 11 and the lower cross section 12, and the middle cross section 13 is either a solid or hollow portion of the axle-receiving member 15 that extends throughout the entire middle cross section 13. The larger cylindrical cavity 15b extends into a portion of the middle cross section 13 of the hangar 6 which is still a part of the axle-receiving member 15. The axle-receiving member 15 may extend throughout the entire length of the middle cross section 13 with the middle portion being a solid structure or alternatively, a hollow structure. The axle-receiving member 15 is a single continuous piece or tube with a cylindrical shape that can be drilled or tapped into either lateral surface 6b of the hangar 6 with portions of the axle-receiving member 15 externally and outwardly extended to retain the wheels 3 as shown on both sides of the hangar 6. Alternatively, the axle-receiving members 15 are two separate structures or tubes with a cylindrical shape that can be drilled or tapped into each lateral surface 6b of the hangar 6, particularly if the middle portion 13 is solidly filled with the same material as used to make the base portion 6a of the hangar 6. Utilizing a single continuous piece or tube with a cylindrical shape that may be solid or hollow is preferred for uniformity in strength extending across the entire middle cross section 13 between the upper cross section 11 and lower cross section 12 of the base portion 6a.

The smaller cylindrical cavity 18 to accommodate the end portion 2d of the removable axle 2 has preferably an internally threaded portion 19 to which the end portion 2d removably and threadably engages the removable axle 2. The removable axle 2 is threadably and removably engaged against the threaded portion 19 of the smaller cylindrical cavity 18 and the locking member 7 (illustrated in FIG. 1) as shown on the right side of the fully assembled removable wheel system 10. The locking member 7 can be comprised of a nylon nubbin, a small protrusion, plastic knob, locktite structure, or the like to create friction against the threaded portion 19 of the smaller cylindrical cavity 18 to prevent disengaging of the removable axle 2 due to continued use and the rigors of skateboarding by users.

As shown on the right side of the removable wheel system 10 in FIG. 3, the removable axle 2 tightly and removably engages the wheel 3 against the base portion 6a of the hangar 6. The end portion 2d of the removable axle 2 is removably engaged and connected to the base portion 6a, more particularly the middle cross section 13, by being fully threaded against the threaded portion 19 of the smaller cylindrical cavity 18 until the axle shoulder 2f rests against the axle shoulder-receiving portion. The removable axle 2 is removably and tightly engaged to the hangar 6 and simultaneously, the body portion 2c is almost entirely filling up the larger cylindrical cavity 15b of the axle-receiving member 15 as shown in FIG. 3.

The length of the removable axle 2 is a bit longer than the internal length of the central opening 3b of the wheel 3. Because the removable axle 2 fits into the axle-receiving member 15 and extends into the central cavity 15b, 18 of the hangar 6, the length of the removable axle 2 is at least the length of the central opening 3b. The removable axle 2, which may be a spline or a bolt, is preferably manufactured from materials that will not be sheared from the load applied by the skateboard.

The fully assembled removable wheel system 10 retains the optional shield 4 and the wheel 3 in between the head portion 2a of the axle 2 and the base portion 6a of the hangar 6. Upon complete assembly of the removable wheel system 10, the head portion 2a is preferably at the same y-axis as the outer lateral side of the wheel 3a. In other words, the head portion 2a preferably does not protrude out farther than the outer lateral side of the wheel 3a to create a low-profile and smooth side portions. The smooth side portions of the fully assembled removable wheel system 10 are advantageous to avoid catching clothing, shoe laces, or the like and to further minimize entry of dirt and dust. Therefore, smooth sides of the assembled removable wheel system 10 are highly preferred.

As the removable wheel system 10 is assembled, the base portion 6a of the hangar 6 is attached to the board 30 via the base plate 40 to which the connector 9 and the bushing 25 (illustrated in FIG. 4) are attached. In order to disassemble the removable wheel system 10 to replace or repair the wheels, the removable axle 2 is threadably disengaged by twisting the head portion 2a in a counterclockwise direction. The optional protector 2b if it is not a part of the removable axle 2, the removable axle 2, the wheel 3, and the optional shield 4 are preferably removed from the axle-receiving member 15 at an x-axis.

FIG. 4 is a partial perspective, bottom view of the skateboard attached to the removable wheel system of FIG. 1. As shown, the skateboard 50 assembly is easily visualized by attaching the fully assembled removable wheel system 10 to the other components of the skateboard 50. The skateboard 50 comprises the removable axles 2, wheels 3, hangar 6, base plate 40, and board 30. If using the removable wheel system 10 as a skateboard, it is preferred that the hangar 6 be attached to a base plate 40 so it may pivot about the base plate's 40 center. The base plate 40 is preferably attached to the board 30 via tightening through the mounting holes 41 to support the weight of user on the board 30.

While the specific indication of sizes and distances set forth herein indicate one embodiment of the present invention, variations may exist that go beyond these specifications either relatively or unilaterally with respect to individual ones of such distances and specifications.

Although the invention has been described with reference to specific embodiments, this description is not meant to be construed in a limited sense. Various modifications of the disclosed embodiments, as well as alternative embodiments of the invention will become apparent to persons skilled in the art upon reference to the description of the invention. The terms and expressions that have been employed in the foregoing specification are used as terms of description and not of limitation, and are not intended to exclude equivalents of the features shown and described or portions of them. For example, the term “side” is analogously used to refer to “surface.” The term “portion” is analogously used to refer to “section.” The scope of the invention is defined and limited only by the claims that follow.

What is claimed is:

1. A removable wheel system comprising:
a removable axle having a head portion, a body portion, and an end portion;
a wheel having a central opening through which the removable axle slidably passes; and
a hangar having a base portion and an axle-receiving member on each lateral side of the base portion, the axle-receiving member having a cylindrical cavity into which each of the removable axles fits and extends into the cylindrical cavity of the base portion;
whereby the axle is removably connected to the hangar and attaches the wheel to the hangar.

2. The removable wheel system of claim 1, wherein the removable wheel system is adapted for attachment to a skateboard.

3. The removable wheel system of claim 1, wherein the head portion of the removable axle comprises any means to tighten the removable axle against the hangar.

4. The removable wheel system of claim 1, wherein the removable axle optionally comprises a protector with a larger surface area than the head portion disposed between the head and body portions to prevent debris from entering the system.

5. The removable wheel system of claim 1, wherein the removable axle optionally comprises a pre-manufactured protector with a larger surface area than the head portion, which protector is disposed between the head and body portions to prevent debris from entering the system.

6. The removable wheel system of claim 1, wherein the end portion of the removable axle comprises a threaded surface.

7. The removable wheel system of claim 1, wherein the end portion of the removable axle includes a locking member that locks the axle to the base portion of the hangar.

8. The removable wheel of system of claim 1, wherein the system comprises an optional shield of a substantially circular and flat-disc shape disposed over the axle-receiving member and between the wheel and the hangar.

9. The removable wheel of system of claim 8, wherein the shield comprises a separate structure or a built-in part on a lateral portion of the hangar and around the axle-receiving member.

10. The removable wheel of system of claim 1, wherein the axle-receiving member is constructed of a stronger material than the base portion of the hangar to withstand stress imposed on the system.

11. The removable wheel of system of claim 1, wherein the axle is removably connected to the hangar by passing through the central opening of the wheel and the central cavity of the axle-receiving member and threading into the central cavity of the base portion of the hangar.

12. A removable wheel system of a skateboard comprising:
a removable axle having a head portion, a protector, a body portion, and an end portion, the end portion having a threaded surface, and the protector having a substantially circular shape coupled between the head portion and the body portion to prevent debris from entering the system;
a wheel with a central opening through which the removable axle slidably passes; and
a hangar having a base portion and an axle-receiving member on each lateral side of the base portion, the axle-receiving member having a larger cylindrical cavity into which each of the body portions of the removable axles fits and a smaller cylindrical cavity defining an internally threaded surface into which the end portion of the axle extends;
whereby the axle threadably engages the internally threaded surface of the smaller cylindrical cavity to engage the axle and attach the wheel to the hangar.

13. The removable wheel system of claim 12, wherein the removable axle comprises a pre-manufactured bolt.

14. The removable wheel system of claim 12, wherein the head portion of the removable axle is comprised of a hex head, socket, multi-sided head, screw cap, or a head cap to tighten the removable axle against the hangar.

15. The removable wheel system of claim 12, wherein the end portion of the removable axle comprises a locking member that locks the axle into the smaller cylindrical cavity of the base portion of the hangar to prevent the axle from threadably disengaging due to continued use of the skateboard.

16. The removable wheel system of claim 12, wherein the axle-receiving member is a single structure of a substantially cylindrical shape that extends throughout a middle cross section of the hangar.

17. The removable wheel system of claim 16, wherein the axle-receiving member comprises a solid middle portion or a hollow middle portion between each of the small cylindrical cavities.

18. The removable wheel system of claim 12, wherein the system comprises an optional shield of a substantially circular and flat-disc shape disposed over the axle-receiving member and between the wheel and the hangar.

19. The removable wheel system of claim 18, wherein the shield comprises a separate structure.

20. The removable wheel system of claim 18, wherein the shield comprises a pre-manufactured part on a lateral surface of the hangar and around the axle-receiving member.

21. The removable wheel system of claim 12, wherein the axle-receiving member comprises a stronger material than the base portion of the hangar to withstand stress imposed on the system due to continued use of the skateboard.
